(19) United States
(12) Patent Application Publication
(10) Pub. No.: US 2008/0024698 A1
(43) Pub. Date: Jan. 31, 2008

(54) Liquid crystal display apparatus and light emitting unit

(75) Inventor: Feng-Li Lin, Taishan Township (TW)

Correspondence Address: BIRCH STEWART KOLASCH & BIRCH, PO BOX 747, FALLS CHURCH, VA, 22040-0747, US

(73) Assignee: Gigno Technology Co., Ltd.

(21) Appl. No.: 11/878,102

(22) Filed: Jul. 20, 2007

(30) Foreign Application Priority Data
Jul. 25, 2006 (TW) 095127180
Jul. 25, 2006 (TW) 095127181
Aug. 17, 2006 (CN) 200610112185.0
Aug. 17, 2006 (CN) 200610112186.5

(51) Int. Cl. G02F 1/13357; F21S 10/00

(52) U.S. Cl. 349/62; 349/61; 362/231

(57) ABSTRACT

A liquid crystal display apparatus includes a backlight module and a liquid crystal display panel. The backlight module includes a back plate and a plurality of lamp sets. The lamp sets are disposed on the back plate. Each of the lamp sets includes a plurality of lamps for emitting lights of at least two colors. The liquid crystal display panel is disposed adjacent to the backlight module. A light emitting unit is also disclosed.

### CROSS REFERENCE TO RELATED APPLICATIONS

This Non-provisional application claims priority under 35 U.S.C. §119(a) on Patent Application Nos. 095127180 and 095127181 filed in Taiwan, Republic of China on Jul. 25, 2006, the entire contents of which are hereby incorporated by reference.

### BACKGROUND OF THE INVENTION

1. Field of Invention

The invention relates to a liquid crystal display apparatus and a light emitting unit, and, in particular, to a liquid crystal display apparatus and a light emitting unit having a plurality of lamps.

2. Related Art

Recently, various kinds of portable electronic devices have appeared in our lives, so the requirements for the display apparatuses with compact size and low power consumption that used in the electronic devices are increasing. The light crystal display (LCD) apparatus is one of the most popular display apparatuses due to its low power consumption, low heat generation, light and non-radiation properties. Moreover, the LCD apparatus has replaced the traditional cold cathode tube (CRT) display apparatus.

As shown in FIG. 1, an LCD apparatus 10 mainly includes an LCD panel 11 and a backlight module 12. The LCD panel 11 is composed of two substrates and a liquid crystal layer disposed between the substrates. The backlight module 12 has a light source for emitting light and outputs the light to the LCD panel uniformly. The light source of the backlight module 12 is usually a cold cathode fluorescent lamp (CCFL) or a light emitting diode (LED). In the case shown in FIG. 1, the light source includes several CCFLs 121. The light emitted from the CCFLs 121 passes through an optical layer set 122 so as to obtain more uniform and directional light.

Although the fluorescent lamps includes the CCFLs and the hot cathode fluorescent lamps, the CCFLs are the superior choice for the light source of the LCD because the CCFLs have cold cathode electrodes instead of the conventional hot cathode electrode, such as the tungsten filaments. By using the cold cathode electrodes, the CCFLs can be started at low temperature and have good performance and durability.

To prevent the color shifting in the LCD, the manufactures usually adjust the white light emitted by the backlight modules to meet the white balance points. Each of the white balance points corresponds to a preset coordinate in the chromaticity diagram and is set depending on each of the manufacturers. The white balance points must show that the red, blue and green colors, which construct the white light emitted by the backlight modules, keep in a certain ratio without biasing towards anyone of the three colors.

Since the white balance depends on the fluorescent material of the CCFLs in the backlight module, in the prior art, the user can only change the data operation value of the frame in the LCD panel so as to adjust the white balance as his/her desire. The chromaticity diagram can be shifted when the data operation values corresponding to the pixels of different colors are changed. Accordingly, the user may feel that the white balance of the image is changed.

Once the data operation value is changed for adjusting the white balance, however, the operation processes of the frame will become more complex. Moreover, some bits of the color levels will be occupied, which results in the decrease of bit depth and further in the poor image display.

Despite the white balance problem, the conventional LCD display also has an image blur problem. Since the LCD display is a hold-type display, the viewer will see the blurring image when the viewer's eyes are tracing the moving object on the screen of the LCD display. To solve the image blur problem, a blinking technology, which is to turn on and turn off the backlight module in turn to simulate the pulse-type display, is disclosed. However, the backlight module is continuously turned on and off, so the brightness of the display varies, resulting in the flicker problem.

Therefore, it is an important subject to provide an LCD apparatus and light emitting unit that allow the user to manually adjust the white balance without affecting the image display and are capable of preventing the image blur problem and flicker problem.

### SUMMARY OF THE INVENTION

In view of the foregoing, the invention is to provide an LCD apparatus and a light emitting unit that can allow the user to manually adjust the white balance without affecting the image display.

In addition, the invention is also to provide an LCD apparatus and a light emitting unit that can prevent the image blur and flicker problem.

To achieve the above, the invention discloses an LCD apparatus, which includes a backlight module and an LCD panel. The backlight module includes a back plate and a plurality of lamp sets disposed on the back plate. Each of the lamp sets includes a plurality of lamps and emits lights of at least two colors. The LCD panel is disposed adjacent to the backlight module.

To achieve the above, the invention also discloses a light emitting unit, which includes a back plate and a plurality of lamp sets. The lamp sets are disposed on the back plate, and each of the lamp sets includes a plurality of lamps and emits lights of at least two colors.

As mentioned above, in the LCD apparatus and light emitting unit of the invention, each lamp set includes a plurality of lamps for emitting lights of at least two colors. Therefore, the lamps in each lamp set can respectively emit lights of different colors, which are mixed to generate the white light emitting out from the backlight module or the light emitting unit. Furthermore, the illuminations of the lamps can be individually adjusted. Accordingly, each lamp set can simulate a single lamp for emitting white light, and the illumination weights of red, blue and green colors can be separately adjusted by other circuits. Under this architecture, the user can manually adjust the white balance to satisfy different visual requirements. In addition, the invention can adjust the white balance of the LCD apparatus by adjusting the light intensities of the lamps of different colors, so the bit depth of the LCD panel is not decreased so as to ensure the image display quality of the LCD apparatus. Moreover, the LCD apparatus and light emitting unit of the invention can have lamps of different colors, which flash in sequence. Accordingly, the image blur problem and flicker problem can be avoided.

### BRIEF DESCRIPTION OF THE DRAWINGS

The invention will become more fully understood from the detailed description given herein below illustration only, and thus is not limitative of the present invention, and wherein:

FIG. 1 is a schematic view of a conventional LCD apparatus;

FIG. 2 is a schematic view of an LCD apparatus according to a first embodiment of the invention;

FIG. 3 is a schematic view of another LCD apparatus according to the first embodiment of the invention;

FIG. 4 is a schematic view of an LCD apparatus according to a second embodiment of the invention;

FIG. 5 is a schematic view of another LCD apparatus according to the second embodiment of the invention;

FIG. 6 is a schematic view of an LCD apparatus according to a third embodiment of the invention;

FIG. 7 is a schematic view showing a light-guiding element of the backlight module in the LCD apparatus according to the third embodiment of the invention;

FIGS. 8A to 8C are schematic views showing several aspects of the light-guiding element according to the third embodiment of the invention;

FIG. 9 is a schematic view of another LCD apparatus according to the third embodiment of the invention;

FIG. 10 is a schematic view of an LCD apparatus according to a fourth embodiment of the invention;

FIG. 11 is a schematic view showing a light-guiding element of the backlight module in the LCD apparatus according to the fourth embodiment of the invention;

FIGS. 12A to 12C are schematic views showing several aspects of the light-guiding element according to the fourth embodiment of the invention;

FIG. 13 is a schematic view of another LCD apparatus according to the fourth embodiment of the invention; and

FIG. 14 is a schematic view of still another LCD apparatus according to the fourth embodiment of the invention.

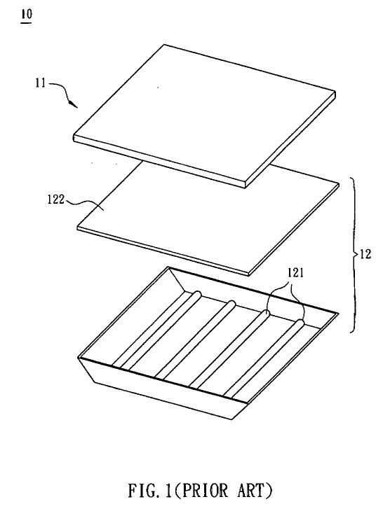

### DETAILED DESCRIPTION OF THE INVENTION

The present invention will be apparent from the following detailed description, which proceeds with reference to the accompanying drawings, wherein the same references relate to the same elements.

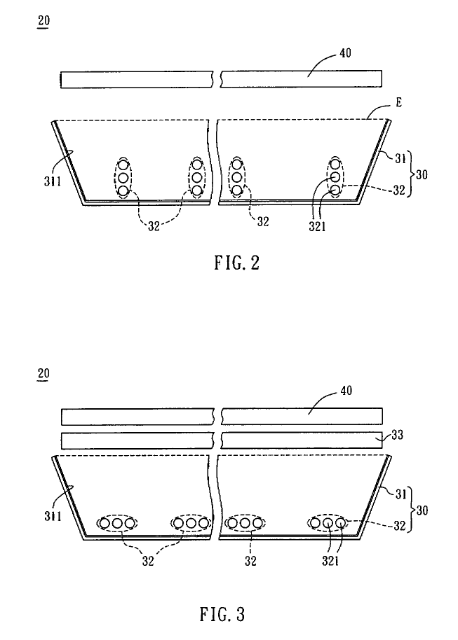

Hereinafter, several embodiments of the invention will be illustrated with reference to FIG. 2 to FIG. 14.

### First Embodiment

As shown in FIGS. 2 and 3, an LCD apparatus 20 includes a backlight module 30 and an LCD panel 40.

The backlight module 30 includes a back plate 31 and a plurality of lamp sets 32. The material of the back plate 31 is usually metal, so the back plate 31 can be made by pressing formation. In the embodiment, the back plate 31 has a reflective layer 311 to reflect the light emitted from the lamp sets 32 so as to increase the light usage. The reflective layer 311 is disposed opposite to the lamp sets 32. For example, the reflective layer 311 can be formed by attaching a reflective film on the back plate 31 or by coating a metal layer on the back plate 31.

The lamp sets 32 are disposed on the back plate 31. Each of the lamp sets 32 includes a plurality of lamps 321, which can emit lights of at least two colors. In the embodiment, the lamps 321 are CCFLs, and they can be linear lamps, U-shaped lamps or W-shaped lamps. As shown in FIG. 2, the lamps 321 are linear lamps. Each lamp set 32 can emit lights of at least two colors, such as two or more complementary colors. In the embodiment, each lamp set 32 can emit lights of three colors such as red, blue and green. In addition, the lamps 321 can be simultaneously or non-simultaneously lighted up. As the lamps 321 are non-simultaneously lighted up, the lamps 321 are flashing in sequence. Thus, the lamps 321 of different colors can be turned on and off in turn so as to eliminate the blur problem while displaying the animated image.

In the embodiment, the lamps 321 are stacked on one another along a direction substantially perpendicular to a light-exiting surface E of the backlight module 30. Alternatively, as shown in FIG. 3, the lamps 321 or the lamp sets 32 can be separately arranged in parallel and not stacked on each other.

The backlight module 30 further includes a diffuser 33 disposed on the lamp sets 32 for enhancing the uniformity of the light.

The LCD panel 40 mainly includes two substrates and a liquid crystal layer disposed between the substrates. The LCD panel 40 is disposed adjacent to the backlight module 30. Since the LCD panel 40 is not the major characteristic of the invention, the structure thereof can be the same as the conventional one and is not described.

In summary, each lamp set 32 includes a plurality of lamps 321 for emitting lights of at least two colors, so the lamps 321 in each lamp set 32 can respectively emit lights of different colors, which are mixed to generate the white light emitting out from the backlight module 30. Furthermore, the illuminations of the lamps 321 can be individually adjusted. Accordingly, each lamp set 32 can simulate a single lamp for emitting white light, and the illumination weights of red, blue and green colors can be separately adjusted by other circuits. Under this architecture, the user can manually adjust the white balance to satisfy different visual requirements. In addition, the invention can adjust the white balance of the LCD apparatus by adjusting the light intensities of the lamps of different colors, so the bit depth of the LCD panel is not decreased so as to ensure the image display quality of the LCD apparatus. Furthermore, the lamps 321 of different colors can be turned on and off in turn so as to eliminate the blur problem while displaying the animated image.

### Second Embodiment

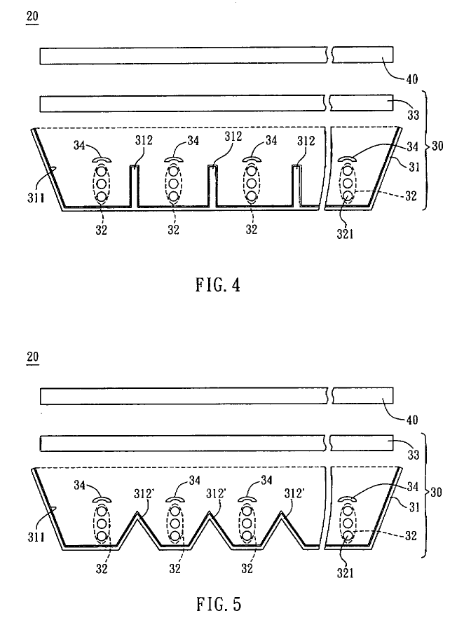

With reference to FIG. 4, the second embodiment is different from the first embodiment by that the back plate 31 of the backlight module 30 in the second embodiment is formed with a plurality of protrusions 312. For example, the protrusions 312 are spacers, and the lamp sets 32 are respectively disposed between the protrusions 312. Furthermore, the surface of each protrusion 312 can be formed with a reflective layer. By disposing the protrusions 312, the lights emitted from different lamp sets 32 are not interfered by each other, which is helpful for controlling the illumination and white balance of the lamp set 32 or controlling the sequential on/off of the lamp sets 32.

In the second embodiment, the backlight module 30 may further include a plurality of reflective covers 34 disposed corresponding to the lamp sets 32, respectively. The reflective covers 34 can be directly disposed over the lamp sets 32 to prevent the light from focusing at the place over the lamp sets 32, which causes the bright zone. Therefore, the thickness of the diffuser 33 can be decreased and the cost of the diffuser 33 is thus reduced.

As shown in FIG. 5, the protrusions 312 can be protruding portions of the back plate 31. The protruding portions, for example, are formed by pressing formation, so that the back plate 31 and the protrusions 312 are integrally formed. The lamp sets 32 are separated by the protrusions 312. In this case, the cost for the spacers is unnecessary.

### Third Embodiment

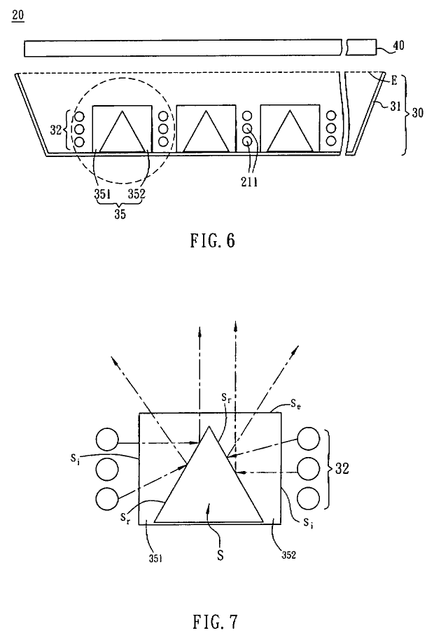

With reference to FIG. 6, the third embodiment is different from the first embodiment by that the backlight module 30 of the LCD apparatus 20 further includes a plurality of light-guiding elements 35 disposed between the lamp sets 32. The light-guiding elements 35, which are made of optical resin such as polycarbonate (PC), can transmit the light emitted by the lamps 321 to the light-exit surface E. Each light-guiding element 35 includes a first light-guiding portion 351 and a second light-guiding portion 352. The shapes of the first light-guiding portion 351 and second light-guiding portion 352 are not limited. For example, the cross section of the first light-guiding portion 351 or the second light-guiding portion 352 can be trapezoid, triangular or other shape. In this embodiment, the cross section of the first light-guiding portion 351 and the second light-guiding portion 352 is trapezoid.

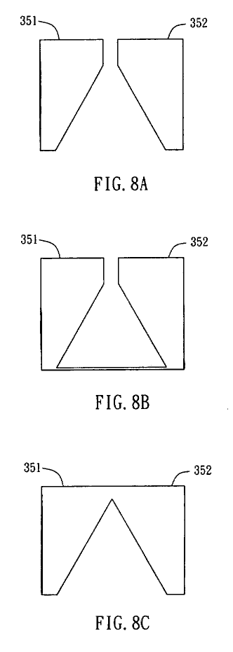

FIG. 7 is an enlarged view of the dot line portion shown in FIG. 6. FIGS. 8A to 8C show several aspects of the connection between the first light-guiding portion 351 and the second light-guiding portion 352. As shown in FIG. 7, each of the first light-guiding portion 351 and the second light-guiding portion 352 has a light-entering surface Sᵢ, a reflective surface Sᵣ and a light-exiting surface Sₑ. The light emitted from each lamp set 32 enters the light-guiding element 35 through the light-entering surface Sᵢ. Then, the light is reflected by the reflective surface Sᵣ of the first light-guiding portion 351 or the second light-guiding portion 352, and then exits the light-guiding element 35 through the light-exiting surface Sₑ of the first light-guiding portion 351 or the second light-guiding portion 352. Thus, the backlight module 30 can be a surface light source.

The first light-guiding portion 351 and the second light-guiding portion 352 can be disposed adjacent to each other or connected with each other. The first light-guiding portion 351 and the second light-guiding portion 352 can be connected with each other to form a hollow pillar by adhering, hooking or locking; otherwise, they can be integrally formed. As shown in FIGS. 8A to 8C, the first light-guiding portion 351 is disposed adjacent to the second light-guiding portion 352 (see FIG. 8A) or partially connected to the second light-guiding portion 352 (see FIGS. 8B and 8C).

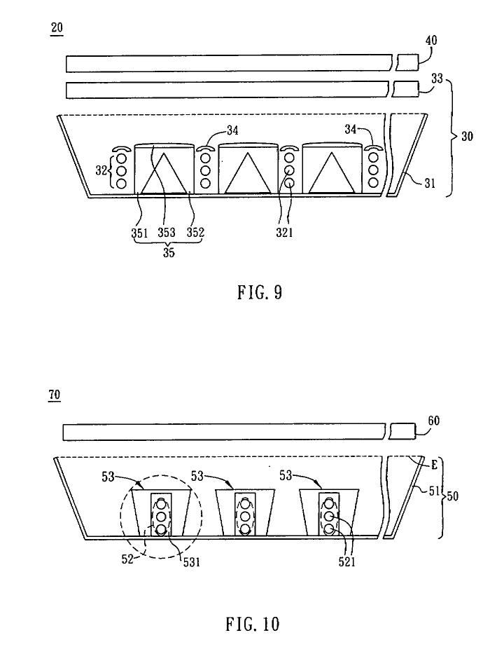

Referring to FIGS. 7 and 9, the light-entering surface Sᵢ may have a microstructure or be formed with an anti-reflective film for lowering the light reflection and increasing the amount of light emitted by the lamps 321 that enters the light-guiding elements 35. The light-reflective surface Sᵣ can be disposed in a chamber S of the light-guiding element 35. By the angle (e.g. the total reflective angle) of the light-reflective surface Sᵣ or forming a reflective layer on the light-reflective surface Sᵣ, most of the light entered the light-guiding elements 35 can be reflected to the light-exiting surface Sₑ. The light-exiting surface Sₑ may have a microstructure or a diffusing unit 353 such as a lens or a diffusing layer for modifying the light shape of the light outputted from the light-guiding element 35. In addition, the backlight module 30 further includes a plurality of reflective covers 34 disposed corresponding to the lamp sets 32, respectively, and a diffuser 33 disposed over the lamp sets 32 for enhancing the uniformity of light.

### Fourth Embodiment

With reference to FIG. 10, an LCD apparatus 70 includes a backlight module 50 and an LCD panel 60. The function and structure of the LCD panel 60 are the same as those of the LCD panel 40 of the first embodiment, so the detailed descriptions are omitted.

The backlight module 50 includes a back plate 51, a plurality of lamp sets 52 and a plurality of light-guiding elements 53. Each of the lamp sets 52 includes a plurality of lamps 521, which can emit lights of at least two colors. The feature and function of the back plate 51 and lamp sets 52 are the same as those of the back plate 31 and lamp sets 32 of the first embodiment, so the detailed descriptions are omitted.

Each light-guiding element 53 includes an accommodating space 531, and the lamp sets 52 are disposed in the accommodating spaces 531, respectively. In addition, the lamp set 52 can be embedded in the accommodating spaces 531 by pressing formation or injection formation. The light-guiding elements 53, which are made of optical resin such as polycarbonate (PC), can transmit the light emitted by the lamps 521 to the light-exit surface E of the backlight module 50.

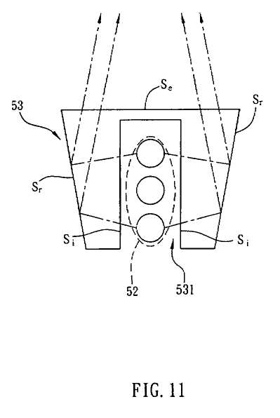

FIG. 11 is an enlarged view of the dot line portion shown in FIG. 10. As shown in FIG. 11, each light-guiding element 53 has two light-entering surfaces Sᵢ, two reflective surfaces Sᵣ and a light-exiting surface Sₑ. The light-entering surfaces Sᵢ are disposed on the inner walls of the accommodating space 531. The light emitted from each lamp set 52 enters the light-guiding element 53 through the light-entering surfaces Sᵢ. Then, the light is reflected by the reflective surfaces Sᵣ, and then exits the light-guiding element 53 through the light-exiting surface Sₑ. Thus, the backlight module 50 can be a surface light source. To be noted, the numbers of the light-entering surface Sᵢ, reflective surface Sᵣ and light-exiting surface Sₑ are not limited and can be determined according to actual needs. Of course, each of the light-entering surface Sᵢ, reflective surface Sᵣ and light-exiting surface Sₑ can be a curve surface.

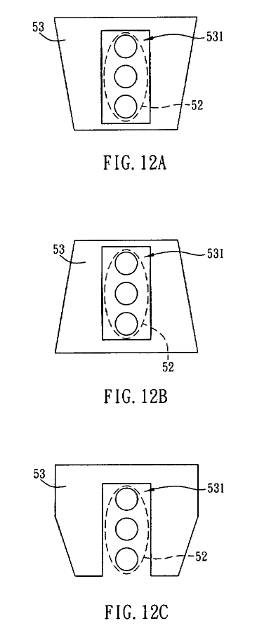

FIGS. 12A to 12C show several aspects of the cross section of the light-guiding element 53. The light-guiding element 53 is a hollow pillar, and the accommodating space 531 is a pillar space (as shown in FIGS. 12A and 12B). Alternatively, as shown in FIG. 12C, the accommodating space 531 is a recess with an opening toward the back plate 51, and the lamp set 52 is disposed in the recess.

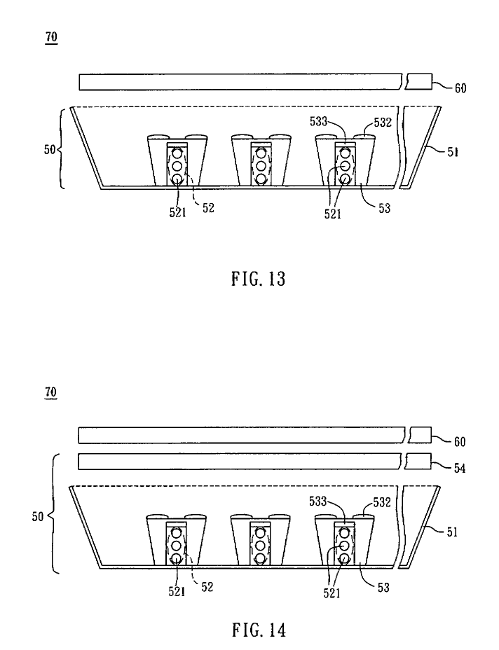

Referring to FIGS. 11 and 13, the light-entering surface Sᵢ may have a microstructure or be formed with an anti-reflective film for lowering the light reflection and increasing the amount of light emitted by the lamps 521 that enters the light-guiding elements 53. By the angle (e.g. the total reflective angle) of the light-reflective surface Sᵣ or forming a reflective layer on the light-reflective surface Sᵣ, most of the light entered the light-guiding elements 53 can be reflected to the light-exiting surface Sₑ. The light-exiting surface Sₑ may have at least one microstructure, dot structure or diffusing unit 532 such as a lens or a diffusing layer for modifying the light shape of the light outputted from the light-guiding element 53. In addition, the light-guiding element 53 may further include a reflective plate 533 or a reflective layer disposed on a part of the light-exiting surface Sₑ, which is closest to the lamp set 52. In other words, the reflective plate 533 or reflective layer is disposed in a corner of the accommodating space 531 closest to the light-exiting surface Sₑ. This configuration can prevent the light from focusing at the place over the lamp sets 52, which causes the bright zone.

Referring to FIG. 14, the backlight module 50 further includes a diffuser 54 disposed over the lamp sets 52 for enhancing the uniformity of light. Alternatively, the backlight module 50 may include other optical element, such as a prism or a diffusing film, for enhancing the uniformity of light.

In addition, the invention discloses a light emitting unit, which includes a back plate and a plurality of lamp sets disposed on the back plate. Each of the lamp sets includes a plurality of lamps, which emit lights of at least two colors. The characteristics and functions of the light emitting unit are the same as those of the backlight module 30 or 50 of the LCD apparatus 20 or 70 in the previous embodiments, so the detailed descriptions are omitted.

To be noted, the light emitting unit can also be used as the lighting unit for other purposes. The user can manually adjust the white balance of the light emitting unit, so that the illuminated light can match the environments such as the indoor or outdoor atmosphere.

In summary, in the LCD apparatus and light emitting unit of the invention, each lamp set includes a plurality of lamps for emitting lights of at least two colors. Therefore, the lamps in each lamp set can respectively emit lights of different colors, which are mixed to generate the white light emitting out from the backlight module or the light emitting unit. Furthermore, the illuminations of the lamps can be individually adjusted. Accordingly, each lamp set can simulate a single lamp for emitting white light, and the illumination weights of red, blue and green colors can be separately adjusted by other circuits. Under this architecture, the user can manually adjust the white balance to satisfy different visual requirements. In addition, the invention can adjust the white balance of the LCD apparatus by adjusting the light intensities of the lamps of different colors, so the bit depth of the LCD panel is not decreased so as to ensure the image display quality of the LCD apparatus. Moreover, the LCD apparatus and light emitting unit of the invention can have lamps of different colors, which flash in sequence. Accordingly, the image blur problem and flicker problem can be avoided.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light emitting unit, comprising:
a back plate; and
a plurality of lamp sets disposed on the back plate, wherein each of the lamp sets comprises a plurality of lamps for emitting lights of at least two colors.

2. The light emitting unit of claim 1, wherein a plurality of protrusions are disposed on the back plate, the protrusions are spacers or protruding portions of the back plate, and the lamp sets are respectively disposed between the protrusions.

3. The light emitting unit of claim 1, wherein the lamp sets emits lights of at least two of red color, blue color and green color or any complementary colors.

4. The light emitting unit of claim 1, wherein the lamp sets or the lamps are separately arranged in parallel.

5. The light emitting unit of claim 1, wherein the lamps are stacked on one another along a direction substantially perpendicular to a lighting surface of the light emitting unit.

6. The light emitting unit of claim 1, wherein the lamps are turned on and off by turns.

7. The light emitting unit of claim 1, further comprising:
a plurality of light-guiding elements disposed between the lamp sets, respectively, wherein each of the light-guiding elements comprises a first light-guiding portion and a second light-guiding portion, and the first light-guiding portion and the second light-guiding portion are disposed adjacent to each other or connected with each other.

8. The light emitting unit of claim 7, wherein each of the first light-guiding portion and the second light-guiding portion has a light-entering surface, a reflective surface and a light-exiting surface, and the light emitted from each of the lamp sets enters the light-guiding element through the light-entering surface.

9. The light emitting unit of claim 1, further comprising:
a plurality of light-guiding elements disposed on the back plate, wherein each of the light-guiding elements comprises an accommodating space, and the lamp sets are disposed in the accommodating spaces, respectively.

10. The light emitting unit of claim 9, wherein the accommodating space is a recess with an opening toward the back plate.

11. The light emitting unit of claim 9, wherein the first light-guiding elements further comprises two light-entering surfaces, two reflective surfaces and a light-exiting surface, and the light emitted from each of the lamp sets enters the light-guiding element through the light-entering surfaces, is reflected by the reflective, and then exits the light-guiding element through the light-exiting surface.

12. The light emitting unit of claim 1, further comprising:
a plurality of reflective covers disposed corresponding to the lamp sets, respectively.

13. A liquid crystal display (LCD) apparatus, comprising:
a backlight module comprising a back plate and a plurality of lamp sets, wherein the lamp sets are disposed on the back plate, and each of the lamp sets comprises a plurality of lamps and emits lights of at least two colors; and
a liquid crystal display (LCD) panel disposed adjacent to the backlight module.

14. The LCD apparatus of claim 13, wherein a plurality of protrusions are disposed on the back plate, the protrusions are spacers or protruding portions of the back plate, and the lamp sets are respectively disposed between the protrusions.

15. The LCD apparatus of claim 13, wherein the lamp sets emits lights of at least two of red color, blue color and green color or any complementary colors.

16. The LCD apparatus of claim 13, wherein the lamp sets or the lamps are separately arranged in parallel.

17. The LCD apparatus of claim 13, wherein the lamps are stacked on one another along a direction substantially perpendicular to a light-exiting surface of the light emitting unit.

18. The LCD apparatus of claim 13, wherein the lamps are turned on and off by turns.

19. The LCD apparatus of claim 13, further comprising:
a plurality of light-guiding elements disposed between the lamp sets, respectively, wherein each of the light-guiding elements comprises a first light-guiding portion and a second light-guiding portion, and the first light-guiding portion and the second light-guiding portion are disposed adjacent to each other or connected with each other.

20. The LCD apparatus of claim 19, wherein each of the first light-guiding portion and the second light-guiding portion has a light-entering surface, a reflective surface and a light-exiting surface, and the light emitted from each of the lamp sets enters the light-guiding element through the light-entering surface.

21. The LCD apparatus of claim 13, further comprising:
a plurality of light-guiding elements disposed on the back plate, wherein each of the light-guiding elements comprises an accommodating space, and the lamp sets are disposed in the accommodating spaces, respectively.

22. The LCD apparatus of claim 21, wherein the first light-guiding elements further comprises two light-entering surfaces, two reflective surfaces and a light-exiting surface, and the light emitted from each of the lamp sets enters the light-guiding element through the light-entering surfaces, is reflected by the reflective, and then exits the light-guiding element through the light-exiting surface.
